(19) United States
(12) Patent Application Publication
(10) Pub. No.: US 2016/0196736 A1
(43) Pub. Date: Jul. 7, 2016

(54) Personal Protection Device

(71) Applicants: William Chester Nolan, Gibson Island, MD (US); Thomas Augustine Nolan, III, Easton, MD (US); Michael Gormley Nolan, Clarendon Hills, IL (US)

(72) Inventors: William Chester Nolan, Gibson Island, MD (US); Thomas Augustine Nolan, III, Easton, MD (US); Michael Gormley Nolan, Clarendon Hills, IL (US)

(21) Appl. No.: 14/967,005

(22) Filed: Dec. 11, 2015

Related U.S. Application Data
(60) Provisional application No. 62/091,515, filed on Dec. 13, 2014.

(51) Int. Cl. G08B 25/01; H04W 4/02; G08B 25/12; H04W 4/12

(52) U.S. Cl. CPC G08B 25/016; H04W 4/12; H04W 4/02; G08B 25/12

(57) ABSTRACT

A device for protecting a person, comprising a light source, sound source, and a network transceiver. The device is configured to, upon activation by a switch, to emit light and sound at respective frequencies and connect to a mobile device to cause the mobile device to send one or more messages to one or more other devices. The messages can comprise one or more of a location of the device, an identity of a user of the device and a status message.

### CROSS-REFERENCE TO RELATED APPLICATIONS

This application claims priority under 35 USC 119(e) to provisional patent application 62/091515, filed Dec. 13, 2014.

### BACKGROUND OF THE INVENTION

Crime, including personal assault, has been an unfortunate aspect of human society since its beginning. While more prevalent in some areas than others, even in seemingly peaceful communities people can be attacked by others seeking to commit violence. This usually occurs when the victim is in a vulnerable situation, such as walking/jogging alone at night. Certain groups, such as the elderly and women are particularly vulnerable. In addition, every year, thousands of people are attacked by animals, usually dogs, but with the resurgence of wildlife into populated areas, attacks have included animals such as bears and mountain lions. To protect themselves, people have resorted to various means such as pepper spray, self-defense classes, concealed weapons, and walking in groups. However, these means are not always practicable. For example: many jurisdictions forbid pepper spray and/or concealed weapons, self-defense classes require a substantial investment of time and training, and sometimes walking alone cannot be avoided. Therefore, there is a need in the art for a device which enables a person to protect themselves against an attacker while conforming to existing laws in any jurisdiction and without requiring a substantial investment in time and training.

### SUMMARY

It is an object of the present invention to provide a device that provides effective protection for a person under attack from another person or an animal, while conforming to existing laws in any jurisdiction and without requiring a substantial investment in time and training.

To this effect, a personal protection device (PPD) has been developed by the inventors that provides non-lethal, effective defense to disorient/scare away attackers, human or animal, using light and sound transducers, and provides a communicative functionality to transmit messages to family members, friends and/or the authorities to summon assistance.

As will be made clear from a reading of the detailed description, the PPD comprises high-power light and sound sources to disorient/scare away attackers and alert those nearby of the attack. In addition, the PPD comprises a network adapter to cause a mobile device of the user to send one or more messages to specified contacts. The messages are intended to alert the recipients of the distress of the user of the PPD and enable them come to the aid of the user of the PPD and/or summon the police or other authorities to the current location of the user.

### BRIEF DESCRIPTION OF THE DRAWINGS

FIG. 1 illustrates a first embodiment of the mechanical construction of a personal protection device (PPD) from a side view.

FIGS. 2A and 2B illustrates a front and back view of the PPD according to the first embodiment.

FIG. 3 illustrates one embodiment of a control diagram of the PPD.

FIG. 4 illustrates one embodiment of a system that can be used by the PPD to send one or more messages to one or more recipient devices.

FIG. 5 illustrates one embodiment of a method for operation of the PPD.

FIGS. 6A-6C illustrates second thru fourth embodiments of the mechanical construction of the PPD.

FIGS. 7A-7B illustrates a fifth embodiment of the mechanical construction of the PPD.

FIG. 8 illustrates a sixth embodiment of the mechanical construction of the PPD.

FIG. 9 illustrates a glove comprising a sleeve into which the PPD can be inserted.

### DETAILED DESCRIPTION

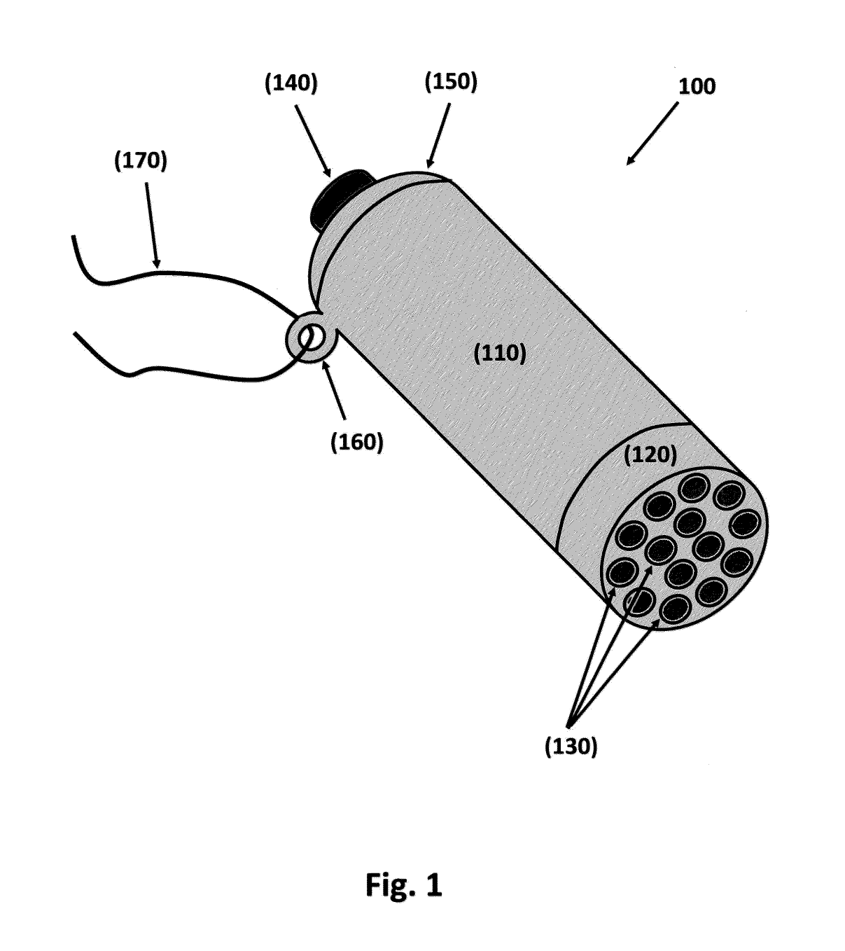

FIG. 1 shows one embodiment of a personal protection device (PPD) 100. PPD 100 comprises a main body composed of a center tube 110, back cover 150, end cap 120, and push-switch switch 140. Also shown is an eyelet 160 that is fixed to tube 110, through which a lanyard 170 or a keychain (not shown) may be threaded. Eyelet 160 may be attached to back cover 150. The lanyard 170 allows PPD 100 to be carried easily around a user's neck and the keychain allows PPD 100 to be carried easily with a user's keys. In the embodiment shown in FIG. 1, end cap 120 is shown having holes 130 for light and/or sound to pass through from light and sound transducers contained inside PPD 100. End cap 120 and back cover 150 can connect to tube 110 via respective threaded attachments, press-fittings, adhesive fittings or any other known mechanical connection type. Although the embodiment shown in FIG. 1 shows device 100 comprising distinct items 110, 120, 150 and 160, it should be appreciated that one or more of items 120, 150 and 160 may be of unitary construction with item 110 or omitted. For example, tube 110 can comprise a two-part casing, in which case one or both of end cap 120 and back cover can be integrated into tube 110. In addition, eyelet 160 may comprise a drilled or molded hole in the side of items 110 or 150, or eyelet 160 may be omitted.

One or all of tube 110, end cap 120, back cover 150 and eyelet 160 may be made of any available metal or plastic but, in a preferred embodiment, at least tube 110 is constructed from metal such as stainless or carbon steel or aluminum, or from a high strength plastic such as ABS or Delrin. To ensure ruggedness of PPD 100, the wall thickness of tube 110 should be at least ⅛″ so that it cannot easily be crushed by an attacker, thus increasing its defensive effectiveness. The wall thickness of end cap 120 and back cover 150 are similarly sized to increase the ruggedness of PPD 100. Openings 130 in end cap 120 are positioned and sized in a manner to allow light and sound through. Openings 130 can be covered in clear plastic or glass to ensure water resistance or water resistance may be provided inside PPD 100 in the form of O-ring seals.

The dimensions of tube 110, back cover 150 and end cap 120 are such that it can be easily and comfortably carried in the hand of a user of PPD 100. For example, the diameter of each of items 110, 150 and 120 can range from 50 mm to 150 mm and the length of PPD 100 can range from 75 mm to 150 mm. However, the length of PPD 100 should be such that an average person can grasp PPD 100 along its length with the ability to press switch 140 while the face of end cap 120 is unobstructed so that the sound and light emanating from PPD 100 is not blocked by the user's hand.

The outside surfaces of items 110, 150 and/or 120 can be knurled to provide increased grip for the user, or can be smooth. In addition, a sleeve of high coefficient of friction material (not shown) could be slipped over the PPD 100 to prevent PPD 100 from loosing from the user's grip.

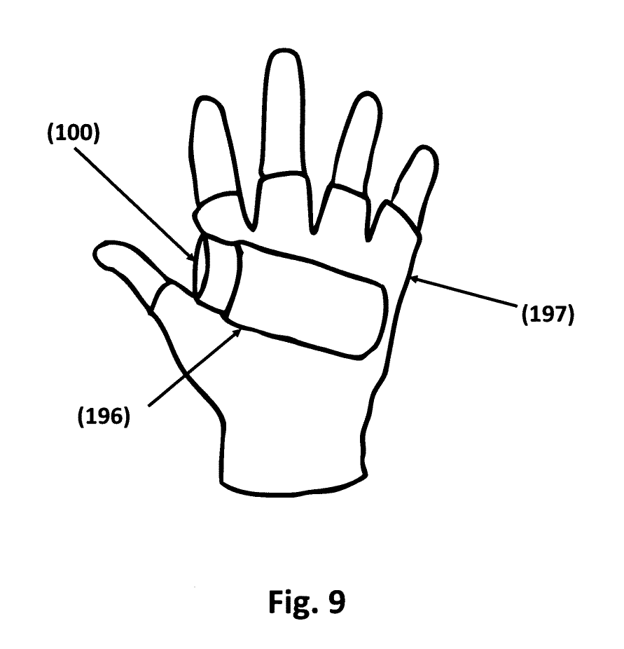

Optionally, an armband or glove in which PPD 100 can be mounted can be provided. The armband or glove would have a sleeve through which the PPD 100 would be inserted. The material of the armband or glove, and/or the sleeve, would be flexible enough for the PPD 100 to be easily inserted but still provide a tight fit that would prevent the PPD 100 from easily slipping. Exemplary materials would be neoprene, SPANDEX, or similar materials. FIG. 9 shows an exemplary glove 197 comprising a sleeve 196 into which PPD 100 is inserted.

Although button 140 is shown as extending outward from the back cover 150, button 140 could also comprise a recessed or concave button that does not extend outward from the back cover 150. This could prevent accidental activations of button 140. In addition, a hinged cover (not shown) could be placed over button 140 to prevent accidental activations. When the user desires to press button 140, the hinged cover could be flipped open to provide access to button 140.

Although not shown, PPD 100 could further comprise a reservoir containing a pressurized irritant, such as pepper spray or teargas. Pressing button 140 could cause the pressurized irritant to be sprayed in the direction at which light sources 230a-n are pointed, in addition to the other functions provided by button 140.

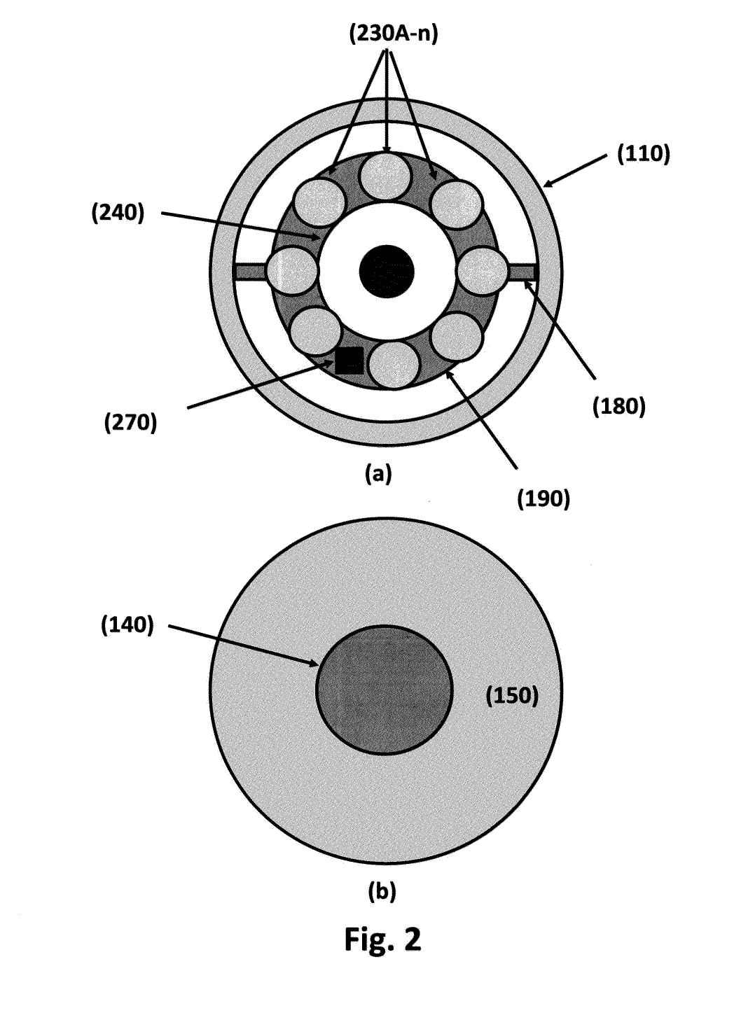

FIG. 2a shows a view of the PPD 100 from the end cap 120 side, with the end cap 120 removed. Shown is printed circuit board 180 on which the control circuitry for PPD 100 is mounted. Also shown is circuit board 190 on which light sources 230a-n and camera 270 are mounted. Sound transducer 240 is also shown, and may be mounted on PCB 190 or PCB 180. FIG. 2a is just an exemplary embodiment and light sources 230a-n and camera 270 may alternatively be mounted on PCB 180, directly or indirectly through a wire harness.

FIG. 2b shows a view of the PPD 100 from the back cover 150 side and shows button 140.

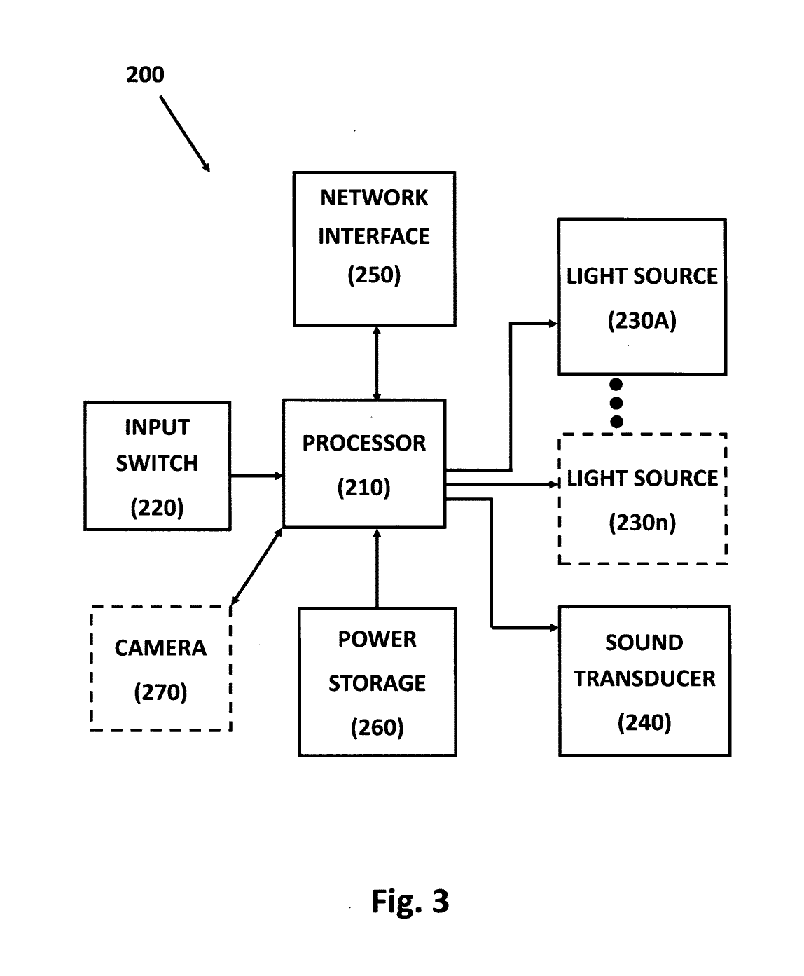

FIG. 3 shows a representation of an electronic circuit 200 contained within PPD 100. Electronic circuit 200 comprises a processor 210, input switch 220, corresponding to switch 140, light sources 230A-230n, sound transducer 240, network interface 250, power storage 260 and optional camera 270. Processor 210 comprises a CPU, such as an embedded microcontroller, and associated support circuitry. Processor 210 is configured with embedded software to monitor and/or control the other devices 220-270 in circuit 200. Light sources 230A-n may comprise, for example, one or more light-emitting diodes (LEDs), electroluminescent panels, or incandescent lamps. Sound transducer 240 may comprise a piezo buzzer, speaker or magnetic buzzer. Network interface 250 may comprise a Bluetooth, WiFi, cellular or other communication transceiver to enable PPD 100 to communicate with one or more other devices over a Personal Area Network (PAN), Local Area Network (LAN) or Wide Area Network (WAN). Power storage 260 may comprise a battery, such a lithium-ion or lithium-polymer battery, or a capacitor. Optional camera 270 comprises an imaging device such as a CMOS sensor or charge coupled device (CCD).

In one embodiment, processor 210 is configured to remain in a low power mode, such as a sleep mode, until a user presses input switch 220. Once switch 220 is pressed, processor 210 exits sleep mode and interprets the switch input. Switch input may comprise one or more activations of switch 220. The number and/or pattern of the activations determine which operation will be performed by processor 210. Alternatively, multiple switches 220 could be provided, with the pressing of each one causing processor 210 to perform respective functions.

In one embodiment, a single switch depression of switch 220 for a specified first duration, i.e. a test pattern, causes processor 210 to enter a test mode wherein it controls light sources 230A-n and sound transducer 240 to emit a test light pattern and/or test sound pattern for a first time period. In one embodiment, the test light and/or sound patterns are configured to enable the user to verify the operation of PPD 100 and/or the power level of power storage device 260. For example, the test light pattern may comprise a single flash to confirm the operation of the device or a series of flashes wherein the number of flashes corresponds to the power level of power storage device 260, e.g. 4 flashes indicating a full charge down to 1 flash indicating a low charge. In a similar manner, the sound test pattern may comprise a single beep/chirp to confirm the operation of the device or a series of beeps/chirps wherein the number of beeps/chirps corresponds to the power level of power storage device 260. In addition to, or alternately with, the above confirmation procedure, the single switch depression of switch 220 for the first duration can cause processor 210 to transmit a message using network interface 250 to one or more other devices, the message comprising status and/or power level of power storage device 260.

In addition to, or alternatively with, the above functionality, a single switch depression of switch 220 for a second specified duration, i.e. a program pattern, causes processor 210 to enter a programming mode wherein it can be configured to pair with, depending on the configuration of network interface 260, a Bluetooth enabled mobile device or other network device. The programming mode may also comprise a sync function where the PPD 100 can be programmed with contact information, such as a telephone number, email address or instant messaging ID.

In one embodiment, pressing switch 220 for at least a specified number of times within a first time period, i.e. an alert pattern, causes processor 210 to enter an alert mode wherein it controls light sources 230A-n and sound transducer 240 to emit an alert light pattern and/or an alert sound pattern for a fourth time period. In addition, in response to the alert pattern, processor 210 may be further configured to control network interface 250 to transmit a message to one or more mobile devices or other network devices and/or take a picture using camera 270. Said message may be composed such that, when received by the one or more mobile devices or other network devices, the one or more mobile devices or other network devices transmit an alert to contacts that have been preselected by the user of PPD 100. In addition, the message may comprise one or more pictures taken by camera 270. The contacts to which an alert is transmitted may further comprise emergency service contacts, such as local police or fire department contacts. These additional contacts may be preprogrammed in PPD 100 or in software residing on the one or more mobile devices or other network devices.

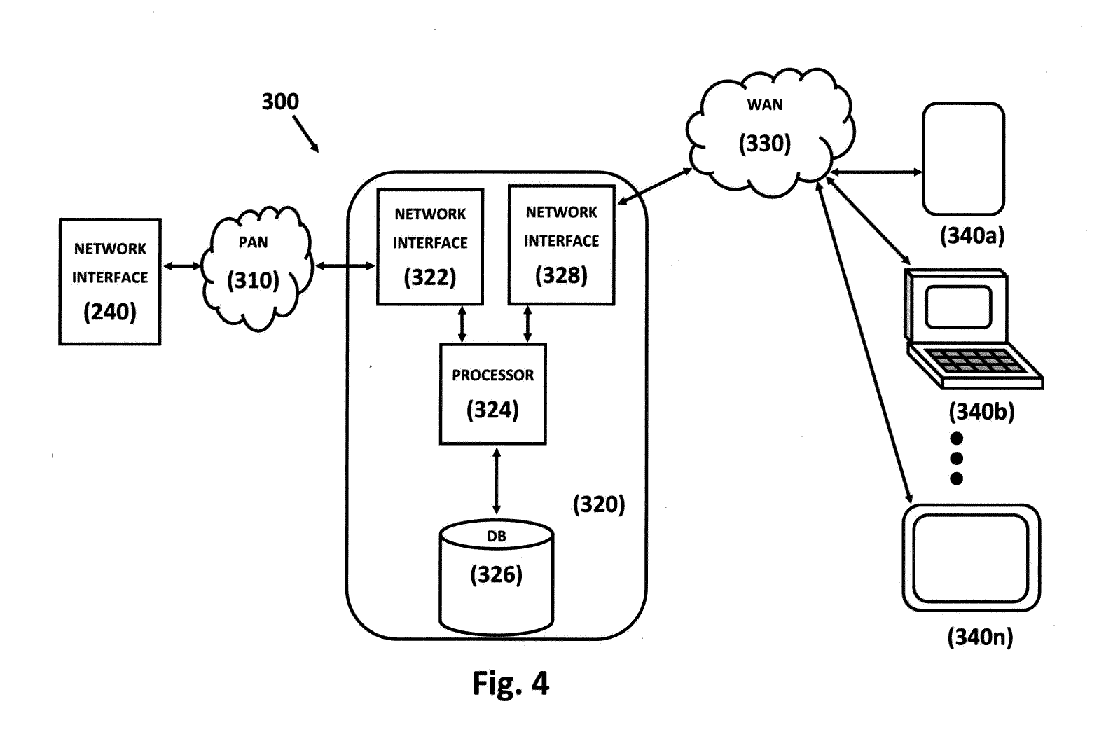

FIG. 4 shows an exemplary system 300 where PPD 100 may be used. System 300 comprises PPD 100, here represented by network interface 250, connected to mobile device 320 over PAN 310. Mobile device 320, in turn, is connected to one or more devices 340a-n over WAN 330. Mobile device 320 may comprise a cellular telephone, personal digital assistant (PDA), vehicle telematics system or other suitable device that can connect to PPD 100 over a PAN 310. Devices 340a-n may comprise a cellular telephone, PDA, personal computer, smart TV, tablet computer or other device that can be connected to a WAN, either directly or through one or more LANs (not shown). PAN 310 can comprise a Bluetooth, IRDA, Zigbee or other commonly known network. In preferred embodiments, PAN 310 would comprise a Bluetooth network because of its widespread availability in cellular phones. WAN 330 can comprise a cellular network (e.g. CMDA, GSM, LTE), satellite telephony network, WiMAX network, the internet, or a combination of any of the above.

It should be appreciated that, in certain embodiments, PPD 100 could be connected to mobile device 320 over a LAN, such as a WiFi network, or WAN instead of PAN 310 and mobile device 320 could be connected to devices 340a-n over a LAN or PAN instead of PAN 310. In addition, in other embodiments, PPD 100 could be connected to a plurality of mobile devices over one or more LANs, WANs or PANs. Also, network interface 250 of PPD 100 could be configured to communicate directly to devices 340a-n over WAN 330 or other network, thus not a requiring mobile device 320. For example, PPD 100 could comprise a cellular network interface 250.

In the embodiment of FIG. 4, when the user has activated switch 220 so as to cause an alert pattern to be recognized by processor 210, processor 210 is configured to enter an alert mode and send a message using network interface 250 to mobile device 320 over PAN 310. The message is received by corresponding network interface 322 of mobile device 320. In embodiments where PAN 310 comprises a Bluetooth network, the message may be formatted according to a message access protocol (MAP), serial port protocol (SPP), human interface protocol (HID) or other suitable protocol. When processor 324 of mobile device 320 detects or is notified that a message has been received by network interface 322, it decodes the message to determine its contents. In embodiments where the alert message comprises contact information, such as an email address or telephone number, processor 324 composes one or more messages to the specified contact(s) and directs network interface 328 to forward the one or more messages to one or more of devices 340a-n over WAN 330. The format of the message(s) may be SMS, MMS, email, IM or cellular telephone call. Multiple messages in different formats may be sent simultaneously. For example, an SMS message may be sent to a device 340 that is a cellular telephone and an email may be sent to a device 340 that is a personal computer. In addition, messages may be sent sequentially. The content of each message may comprise relevant information such as the identity of PPD 100 or its user and/or location information. In addition, each message may comprise other information such as preset text information. For example, a message may comprise text saying “(identity of user) has issued an alert at the following coordinates (latitude/longitude or address information). Please send help!” or similar text. The location information can be generated using an global positioning system (GPS) module (not shown) in mobile device 320 or an GPS module (not shown) in PPD 100.

In embodiments where the alert message transmitted from PPD 100 to mobile device 320 does not comprise contact information, the receipt of the message by network interface 322 may cause processor 324 to read contact information for one or more contacts from DB 326, compose one or messages to the specified contact(s) and direct network interface 328 to transmit the messages to devices 340a-n in the manner described above. DB 326 may comprise a contact list as is commonly found in mobile devices, such as PDAs or cellular phones, or a contact list that is specific to a particular program, such as a social media application or a contact list that is specific to a program that has been written specifically to interpret communications from PPD 100, i.e. an “app”.

Devices 340a-n are configured to receive the messages sent from mobile device 320 over WAN 330. This can be through the use of an email client, SMS messaging application, instant messaging client, web browser, a custom application or, in the case of the message being in the form of a telephone call, a telephone receiver. Each device 340 comprises an output module, such as a screen, speaker or printer, that can be used to present the message to a user of each device 340. Each device 340 can be configured to forward the message to another device 340 and/or send a response message back to mobile device 320. The response message can comprise information such as “Help is on the way” or “Message received. Authorities have been notified”. Devices 340a-n may be located at a police station, fire department, or call center or devices 340a-n may be personal communication devices owned by individuals.

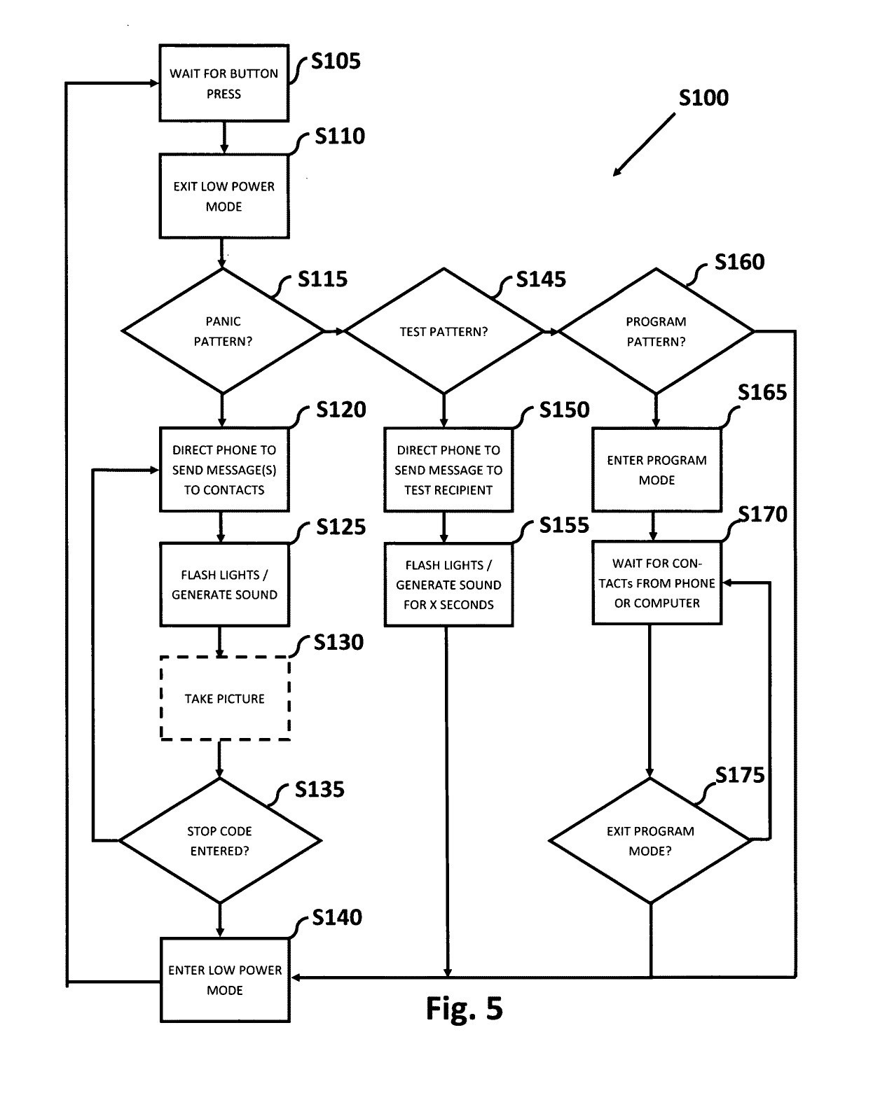

FIG. 5 illustrates a method of operation S100 of PPD 100. Method S100 starts at step S105 where the processor is in a low power state waiting for an indication of switch 150 having been pressed. The indication of switch 150 having been pressed can be provided by a detection of an input pin of the processor having changed state, e.g. moving from high to low. This detection can be accomplished using an interrupt or a polling routine. Although not shown, the waiting for an indication of switch 150 having been pressed can comprise a timer function wherein the processor ‘wakes up’ periodically to measure the state of power storage 260. If the measured state of power storage 260 indicates that power storage 260 is depleted past a certain threshold, the processor could be configured to activate the sound transducer and/or light sources to provide a flash or chirp that serves to indicate that power storage 260 is depleted. Alternatively or in addition to this, processor 210 could direct network interface 250 to send a message to mobile device 320 to cause mobile device 320 to display a message indicating the depletion of power storage 260 and/or to cause mobile device 320 to send a message to one or more of devices 340a-n regarding the depletion of power storage 260. This way, a user of a device 340 could be alerted that PPD 100 needs to be recharged and could notify the user of PPD 100.

Once an indication of switch 150 having been pressed is received, processor 210 exits the low power mode in step S110. Exiting low power mode may also comprise powering network interface 250 and syncing PPD 100 to mobile device 320 or network interface 250 could be powered later and PPD 100 could be synced later. At step S115, it is determined whether the switch press comprises a panic pattern. As mentioned above, a panic pattern may comprise at least a specified number of switch presses within a first time period. If the switch press comprises a panic pattern, the method proceeds to step S120 where PPD 100 sends a message to the mobile device 320 which causes mobile device 320 to send one or more messages to devices 340a-n. If network interface 250 was not powered up in step S110, then it is powered up in step S120 and PPD 100 is synced with mobile device 320. The method then proceeds to step S125 where processor 210 controls lights 230a-n to start flashing according to the panic light pattern. In addition, processor 210 controls sound transducer 240 to start outputting sound according to panic sound pattern. At optional step S130, a picture is taken by camera 270. While not illustrated in FIG. 5, the method could further comprise a step of transmitting the picture to mobile device 320 which stores the picture and/or transmits the picture to devices 340a-n. In addition, the order of steps S120-S130 is not important. For example, the picture could be taken first and then sent with the message sent in step S120 or the light and sound generation started in step S125 can be started before the message is sent and/or the picture is taken. Regardless of the order in which they are performed, once steps S120-S130 have been completed, the process proceeds to step S135 where processor 210 checks whether a stop code from mobile device 320 has been received at network interface 250. In a preferable embodiment, the message sending, light flashing and/or sound generation continues until the stop code is received, as shown by the loop formed between steps S135 and S120. In other embodiments, the message sending, light flashing and the sound generation continues for a specified duration. Although the loop shows all of the message sending, light flashing and sound generation steps S120-S130 being repeated, all or one of the steps could be repeated. It should also be noted that sending messages from mobile device 320 to one or more of devices 340 could continue even if the power source on PPD 100 dies by having mobile device 320 independently continue to send messages once it has received the message from PPD 100 in step S120.

In certain embodiments, the stop code could be sent from mobile device 320 in response to the user of PPD 100 entering a first code using an application resident on mobile device 320 or entering the first code using an application resident on one of the devices 340. In addition, more than one code could be entered. For example, a duress code could be entered by the user. This duress code could cause the PPD 100 to stop the light flashing and sound generation while mobile device 320 continues to send one or more additional messages to one or more of devices 340 to indicate that the user has stopped the light flashing and sound generation but is still in distress. This could occur for many reasons, such as the user hiding from an attacker or being forced by an attacker to stop the light flashing and sound generation.

Once the stop code is received at S135, or the specified duration has occurred, the process continues to step S140 where PPD 100 re-enters the low power mode. This includes stopping the light flashing and/or sound generation and putting processor 210 in a low power mode. In addition, network interface 250 of PPD 100 is powered down at this point in a preferred embodiment. In other embodiments, network interface 250 is not powered down immediately but, rather, is powered down after a specified duration. The process then loops back to step S105.

If, in step S115 it is determined that the panic pattern has not been entered, the process continues to step S145 where it is determined whether the test pattern has been entered. If the test pattern has been entered, the process proceeds to step S150 where, similar to step S120, PPD 100 communicates with mobile device 320, causing mobile device 320 to transmit a test message to a test recipient that has been designated either in PPD 100 or mobile device 320. The content of the message comprises text to ensure that the test recipient recognizes that the message is a test message, such as “Carol's PPD has sent a test message”. Next, in step S155, processor 210 controls lights 230a-n to emit a test light pattern and controls sound transducer 240 to emit a sound test pattern. The light and sound patterns continue for a specified duration. Then, the process continues to step S140 where PPD 100 re-enters the low power mode.

If, in steps S115 and S145, it is determined that neither a panic pattern or a test pattern has been entered, the process continues to step S160 where it is determined whether a program pattern has been entered. If a program pattern has been entered, the process continues to step S165 where PPD 100 enters into a program mode. Program mode is a mode wherein PPD 100 is synced with mobile device 320, i.e. contact information is stored in PPD 100. To notify the operator that PPD 100 has entered the program mode, the processor 210 can control lights 230a-n to emit a program light pattern and control sound transducer 240 to emit a sound pattern. The process continues to step S170 where PPD 100 waits to receive contact information from mobile device 320 or another device that is connected to PPD 100 over PAN 310. This continues until PPD 100 determines that the program mode should be exited from in step S175, at which point the process continues to step S140 where PPD 100 returns the low power mode. The exit of the program mode could be effected by the expiration of a time period during which no transmission is received from mobile device 320, a command received from mobile device 320 signifying the end of the programming mode, or a pressing of switch 220 to cancel the program mode.

It should be appreciated that if PPD 100 is configured to send a message to an app on mobile device 320 and this app comprises the contact information for the messages sent to other devices 340a-n, steps S160-S175 could be omitted.

While not shown, process S100, in addition to steps S115, S145 and S160, could comprise another step of determining whether a pair pattern has been entered using switch 220 and could then enter a pairing mode wherein PPD 100 is paired with mobile device 320, in a manner known in the art.

If, in steps S115, S145 and S160, it is determined that neither a panic pattern, test pattern or program pattern has been entered, the program continues to step S140 where PPD 100 reenters the low power mode. By requiring specific patterns for the panic pattern, test pattern and program pattern, and ignoring switch depressions that do not conform to these patterns, it can be ensured that inadvertent depressions of switch 220 do not cause PPD 100 to activate accidentally.

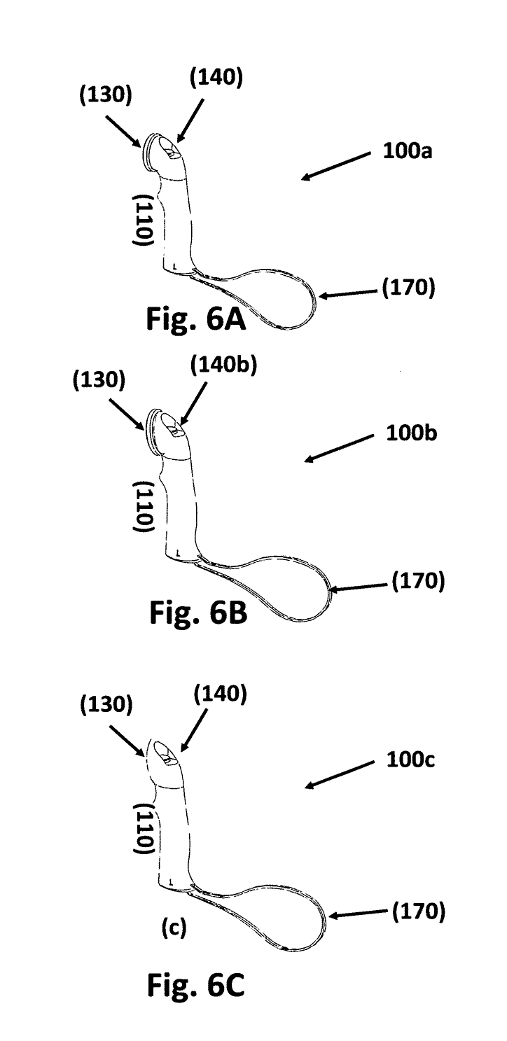

FIGS. 6a-6c illustrate other embodiments of PPD 100. The control circuits and processes of the PPD 100 are the same as those for the embodiment shown in FIG. 1.

In FIG. 6a, a PPD 100a is shown. The body 110 of PPD 100a comprises a grip that can be held by the user of the PPD 100a such that the face 130 of PPD 100a can be pointed forward while PPD 100 is gripped in the vertical orientation shown in FIG. 6a. Also shown is a recessed button 140 to prevent accidental activations. FIGS. 6b-6c show PPDs 100b-100c that are gripped in the same manner as PPD 100a. The difference between each of PPD 100a-100c is in the shape of the face 130, which is for aesthetic reasons.

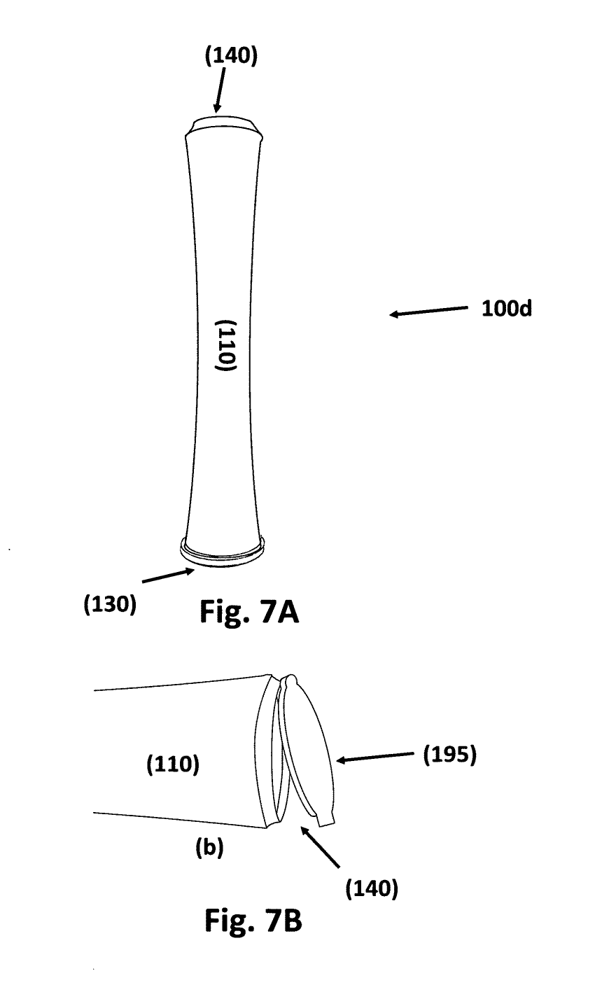

FIG. 7a shows a fifth embodiment of a PPD 100d. The body 110 of PPD 100d is curved for aesthetic reasons and for easy gripping. PPD 100d is similar to PPD 100 shown in FIG. 1 in that end cap 130 is provided at one end of the device and button 140 is provided at the opposite end. PPD 100d is meant to be held such that face 130 is pointed toward an attacker.

Shown in FIG. 7b is another embodiment of a PPD 100d that comprises a hinged button cover 195 that covers button 140 to prevent accidental activations.

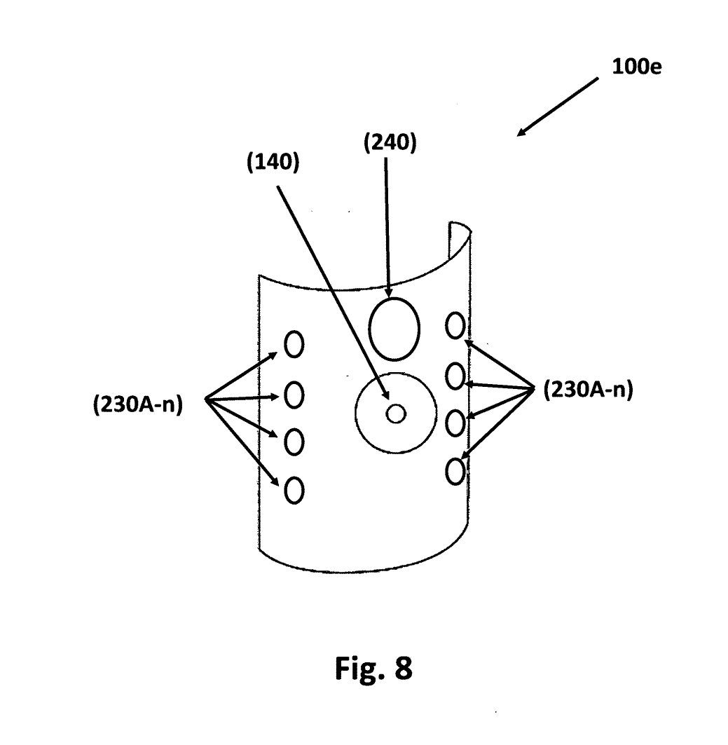

FIG. 8 is a fifth embodiment of a PPD 100e. PPD 100e is designed to fit over an arm of the user such that light sources 230a-n, button 140 and sound transducer 240 are pointed away from the user of PPD 100e. The design of PPD 100e facilitates having two hands free to defend oneself from an attacker.

The above embodiments are meant to be illustrative and should not be construed as limiting the scope of the invention. Many equivalent embodiments that do not depart from the spirit of the present invention will be apparent to one of ordinary skill in the art in light of the above disclosure. This application is intended to cover these equivalent embodiments and other variations, uses or adaptations of the invention that come within the known and customary practice within the art to which the invention pertains.

1. An system comprising: an apparatus comprising: a light source; a sound source; a switch; a network transceiver; and a processor that, upon a first activation of said switch, is configured to: cause said light source to emit light according to a first pattern, cause said sound source to emit sound according to a second pattern, cause said network transceiver to establish a network connection, and transmit first information over said network connection; and one or more devices configured to receive said first information.

2. The system of claim 1, wherein the network connection is to a personal area network and said one or more devices comprise a mobile device connected to said personal area network, wherein said mobile device is configured to, in response to receipt of said first information, transmit one or more messages to one or more preselected recipients defined in a memory of said mobile device.

3. The system of claim 2, wherein the one or more messages each comprise information regarding an identity of a user of said mobile device, information regarding a location of said mobile device, and a status message.

4. The system of claim 3, wherein the status message is set according to the characteristics of the first activation of said switch.

5. The system of claim 2, wherein the mobile device is further configured to repeatedly transmit said one or more messages to said one or more preselected recipients at a preselected frequency.

6. The system of claim 2, wherein, upon a second activation of said switch, the processor of said apparatus is further configured to: cause said light source to stop emitting light, cause said sound source to stop emitting sound, and cause said network transceiver to transmit second information over said network connection, and wherein said mobile device is further configured to, in response to receipt of said second information, transmit one or more second messages to said one or more preselected recipients.

7. The system of claim 6, wherein the one or more second messages each comprise information regarding an identity of a user of said mobile device and a status message.

8. The system of claim 7, wherein the status message is set according to the characteristics of the second activation of said switch.

9. The system of claim 8 wherein said mobile device is further configured to repeatedly transmit said one or more second messages to said one or more preselected recipients at a preselected frequency if said characteristics of the second activation correspond to a first characteristic.

10. The system of claim 9, wherein said first characteristic is a pattern of open and closings of said switch.

11. The system of claim 1, wherein the network connection is to a cellular network and wherein said one or more devices comprise one or more devices connected to said cellular network and capable of displaying said information contained in said transmitted first information, wherein said transmitted first information comprises one or more messages directed to respective ones of said one or more devices, and wherein routing information for each of said one or more devices is stored in a memory of said apparatus.

12. The apparatus of claim 11, wherein the one or more messages each comprise information regarding an identity of a user of said apparatus, information regarding a location of said apparatus, and a status message.

13. The system of claim 12, wherein the processor of said apparatus is further configured to repeatedly transmit said one or more messages to said one or more devices at a preselected frequency.
